(19) United States
(12) Patent Application Publication
(10) Pub. No.: US 2010/0067575 A1
(43) Pub. Date: Mar. 18, 2010

(54) DECODING METHOD, DECORDER AND DECODING APPARATUS

(75) Inventors: Hiroshi NAKAYAMA, Kawasaki (JP); Taro Hagiya, Nerima (JP); Yasuhiro Watanabe, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/561,670

(22) Filed: Sep. 17, 2009

Related U.S. Application Data
(63) Continuation of application No. PCT/JP2007/055621, filed on Mar. 20, 2007.

(51) Int. Cl. H04N 11/02

(52) U.S. Cl. 375/240.12; 375/E07.243

(57) ABSTRACT

A decoding method generates a rectangular residual image by performing an inverse quantization and inverse frequency conversion processes based on coefficient data, a rectangular predicted image by reading a reference image based on motion vector data, and a decoded image by adding the residual image and the predicted image. The predicted images with respect to at least two or more rectangular regions are stored when generating the rectangular predicted image, and a predicted image ready signal notifies that the predicted image with respect to the at least two or more rectangular regions has been generated. The timings to store the coefficient data and the motion vector data are controlled in response to the predicted image ready signal.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2007/055621 filed on Mar. 20, 2007, in the Japanese Patent Office, the disclosure of which is hereby incorporated by reference.

### FIELD

The present embodiment discussed herein relates to decoding methods, decoders and decoding apparatuses.

### BACKGROUND

The dynamic images of digital broadcasting and DVD video that are monitored are made up of approximately 30 digital images per second. Hence, transmitting such dynamic images on a broadcasting wave or, storing such dynamic images on a storage medium such as the DVD, without processing the dynamic images, is difficult from the point of view of the limited frequency band of the broadcasting wave and the limited capacity of the storage medium. For this reason, in actual applications, the dynamic image is subjected to some kind of a compression process. Generally, the compression process is in conformance with a rules prescribed by a standardization organization, by taking into account the public interest and popularity on the market of the application of the compression process. The popularly used compression techniques include the MPEG-2 prescribed by the International Organization for Standardization/International Electrotechnical Commission (ISO/IEC), and the new compression technique called the H.264/Advanced Video Coding (H.264/AVC) which achieves compression rate two times that of the Moving Picture Experts Group 2 (MPEG-2). The H.264/AVC is anticipated as the next-generation compression technique to be employed in Digital Terrestrial Television (DTTV or DTT) broadcasting for mobile equipments, and reproducing apparatuses such as High-Definition DVD (HD-DVD) players/recorders and Blu-ray players/recorders. The dynamic image compression process such as the MPEG-2 and the H.264/AVC is based on the concept of detecting, from the images forming the dynamic image, regions that have a strong correlation, that is, regions that have similar picture patterns, in order to exclude redundant information. Each image is divided (or segmented) into rectangular regions (or areas) which are called macro blocks and are processing units of the compression. With respect to each macro block, and a search is made to find a rectangular region called a reference image which has a picture pattern similar to that of the macro block and is close to the macro block in terms of time. A spatial difference (or error) in positions of the macro block and the reference image that is found is regarded as motion vector data, and the residual data between the images of the macro block and the reference image is regarded as coefficient data. The motion vector data and the coefficient data that are obtained are compressed and encoded.

The apparatus which receives the digital broadcasting and displays the dynamic image or, reproduces the video data from the DVD, includes a dynamic image decoding apparatus which decodes and expands the compressed and encoded data. The dynamic image decoding apparatus generates a predicted image by referring to an image having a similar picture pattern based on the motion vector data, and performs a motion compensation process to add the predicted image and the residual image. In the case of the H.264/AVC, it may be possible to define the motion vector data in processing units of the rectangular regions smaller than that of the MPEG-2, and the processing load on the dynamic image decoding apparatus is larger than that of the MPEG-2, as reported in Impress Standard Textbook Series “H.264/AVC Textbook”, Impress Japan Incorporated, Net Business Company (Publisher), pp. 113-115, Aug. 11, 2004.

For example, with respect to the rectangular region (macro block) having a size of 16×16 pixels=256 pixels as the processing unit, the MPEG-2 requires the luminance values of 17×9 pixels to be read 2 times, that is, 306 pixels to be read as the reference image at the maximum. On the other hand, with respect to the rectangular region (macro block) having a size of 16×16 pixels=256 pixels as the processing unit, the H.264/AVC requires the luminance values of 9×9 pixels to be read 16 times, that is, 1296 pixels to be read as the reference image at the maximum. This means that in a worst case scenario, the H.264/AVC requires 4 times or more data to be read when compared to the MPEG-2.

FIG. 1 is a block diagram illustrating an example of a conventional decoder. The decoder illustrated in FIG. 1 includes an encoded data decoding part 1, a coefficient data processing part 4, a motion vector data processing part 5, a motion compensating part 6, a control part 7, and an image memory 8. The encoded data decoding part 1 interprets the encoded data for each macro block and classifies the encoded data into coefficient data and motion vector data. The encoded data decoding part 1 supplies the coefficient data to the coefficient data processing part 4, and supplies the motion vector data to the motion vector data processing part 5.

The control part 7 controls the operations of the encoded data decoding part 1, the coefficient data processing part 4, the motion vector data processing part 5, and the motion compensating part 6, based on synchronizing signals SYNC which will be described later.

The coefficient data processing part 4 includes a coefficient data interpreting part 41, an inverse quantization part 42, and an inverse frequency conversion part 43. The coefficient data interpreting part 41 converts a macro block attribute in accordance with a compression rule, such as interpreting the order of the coefficient data within the macro block, into a data format handled by hardware. The coefficient data output from the coefficient data interpreting part 41 has been subjected to a quantization at the time of the compression, and thus, is subjected to an inverse quantization process in the inverse quantization part 42. In addition, because the image compression data has been subjected to a spatial and frequency conversion in accordance with the compression rule, the image compression data is then subjected to an inverse frequency conversion process in the inverse frequency conversion part 43, in order to output the residual image that is obtained by subtracting the predicted image from the original image. The residual image includes an error component generated by the compression process such as the spatial and frequency conversion and quantization, and this error component appears as a distortion in the decoded image.

On the other hand, the motion vector data processing part 5 includes a motion vector data interpreting part 51 and a predicted image generating part 53. The motion vector data interpreting part 51 converts the motion vector data into a motion vector which indicates the reference image, in accordance with the compression rule. The predicted image generating part 53 reads the reference image from the image memory 8 using the interpreted motion vector, and generates and outputs the predicted image based on the compression rule.

The motion compensating part 6 adds the residual image output from the coefficient data processing part 4 and the predicted image output from the motion vector data processing part 5 to generate a decoded image, and stores the decoded image in the image memory 8.

When performing the above described processes by hardware in the conventional decoder, a pipeline process is formed for each macro block, and the synchronizing signals SYNC that achieve synchronization for each macro block are output to the control part 7 from each of the encoded data decoding part 1, the coefficient data processing part 4, the motion vector data processing part 5 and the motion compensating part 6. In the decoder which synchronizes to each macro block, the reference image read performance is easy to estimate if the reference to the predicted image is simple as in the case of the MPEG-2, and a stable decoding performance may be obtained without stalling the pipeline system. However, in the case of the H.264/AVC in which the reading of the predicted image varies depending on the number of divisions of the macro blocks and the like, the reference image read performance greatly deteriorates if the number of divisions of the macro blocks is large, and the performance of the decoder as a whole deteriorates due to stalling of the pipeline system. In order to avoid such stalling of the pipeline system, it may be possible to construct the decoder by estimating the required memory performance for a worst case scenario of the reading of the reference image. However, the decoder in this case would require a high-speed memory which is several times faster than that required in the case of the MPEG-2, and consequently, the ease of design of the decoder will deteriorate, and the cost of the decoder will increase.

Next, a description will be given of a timing at which the deterioration of the performance is generated in the conventional dynamic image decoder, by referring to FIGS. 2 and 3. FIG. 2 is a diagram illustrating a structure of the macro block of the decoded image. In FIG. 2, the numeral within each rectangle indicates a macro block number that is assigned to the macro block for the sake of convenience. In addition, white rectangles without the hatching indicate the so-called intra-macro block which may be decoded without performing the motion compensation. On the other hand, rectangles with the hatching indicate the so-called inter-macro block which requires the motion compensation to be decoded.

FIG. 3 illustrates timings of the encoded data decoding process of the encoded data decoding part 1, the motion vector data interpreting process and predicted image generating process for reference image reading process) of the motion vector data processing part 5, the coefficient data interpreting, inverse quantization and inverse frequency conversion process of the coefficient data processing part 4, and the motion compensation process of the motion compensating part 6. In FIG. 3, a phantom arrow indicates the vector data, a solid arrow indicates the coefficient data, X indicates that the reference image reading process immediately ends by a No-Operation (NOP) because there is no reference image for the intro-macro block.

The decoder illustrated in FIG. 1 processes the macro blocks by the pipeline process, and when the encoded data decoding part 1 is processing the macro block number N, the coefficient data processing part 4 and the motion vector data processing part 5 process the macro block number N−1 for which the encoded data decoding process has been completed, and the motion compensating part 6 adds the residual image and the predicted image of the macro block number N−2 for which the inverse frequency conversion process of the inverse frequency conversion process 43 and the predicted image generating process of the predicted image generating part 53 have been completed. For this reason, if the block divisions of the macro block numbers 4, 5 and 6 which require the motion compensation in FIG. 2 are complex, and the processing time required to read the reference image becomes long as in the case of the macro block numbers 4, 5 and 6 illustrated in FIG. 3 and a delay is introduced in the predicted image generating process of the predicted image generating part 53, the start of the motion compensation process of the motion compensating part 6 with respect to the macro block number 6 must wait. As a result, a delay is introduced when making a transition to the next macro block process at each pipeline stage, and the performance of the decoder as a whole deteriorates.

The applicants are aware of a Japanese Laid-Open Patent Publication No. 8-214307, and Impress Standard Textbook Series “H.264/AVC Textbook”, Impress Japan Incorporated, Net Business Company (Publisher), pp. 113-115, Aug. 11, 2004 referred above.

Therefore, in the conventional decoder, if the processing time required to read the reference image with respect to the macro block number becomes long and the delay is introduced in the predicted image generating process, the start of the motion compensation process with respect to the macro block must wait. Thus, a delay is introduced when making the transition to the next macro block process at each pipeline stage, and the performance of the decoder as a whole deteriorates.

### SUMMARY

According to an aspect of the embodiments, a decoding method which decodes video compression data based on motion compensation for divided regions of the video image and decompresses the video compression data into an image that is stored in an image memory, includes decoding the dynamic image compression data and outputting coefficient data and motion vector data; storing the coefficient data in a coefficient data storage part; storing the motion vector data in a motion vector data storage part; generating a rectangular residual image by performing an inverse quantization process and an inverse frequency conversion process based on the coefficient data read from the coefficient data storage part; generating a rectangular predicted image by reading a reference image from the image memory based on the motion vector data read from the motion vector data storage part; generating a decoded image by adding the residual image and the predicted image, and storing the decoded image in the image memory; controlling processing timings of the storing of the coefficient data to the coefficient data storage part and the storing of the motion vector data to the motion vector data storage part; and storing predicted images with respect to at least two or more rectangular regions in a predicted image buffer when generating the rectangular predicted image by reading the reference image from the image memory, and notifying by a predicted image ready signal that the predicted image has been generated, wherein the processing timings are controlled in response to the predicted image ready signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating an example of a conventional decoder;

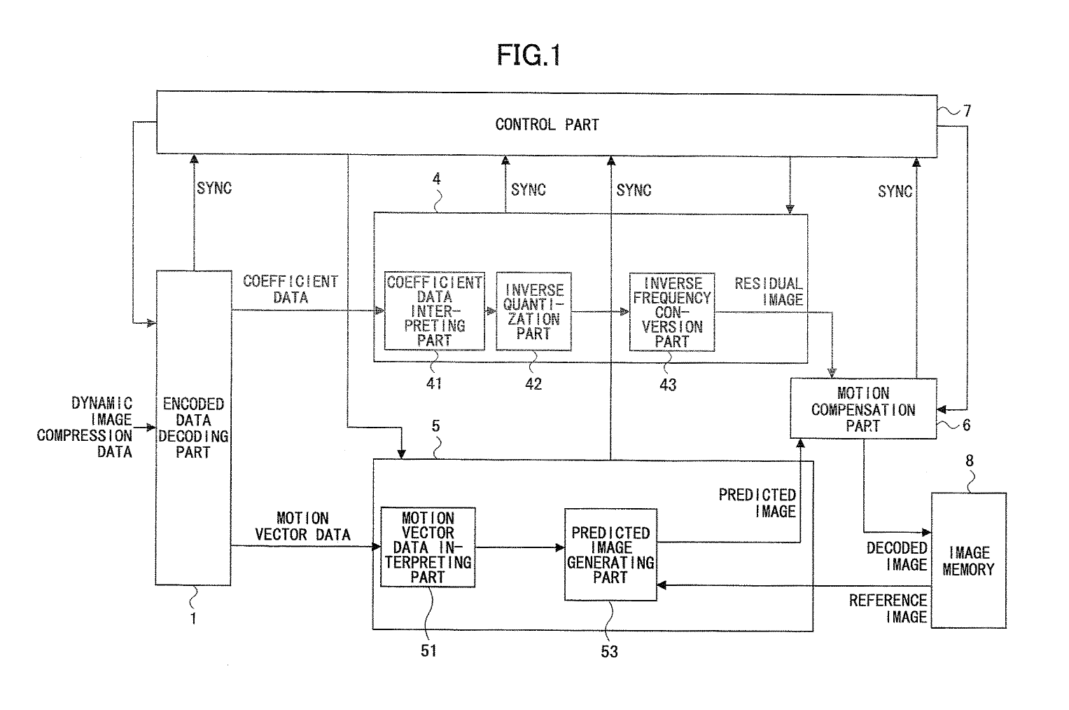

FIG. 2 is a diagram illustrating a structure of a macro block of a decoded image;

FIG. 3 is a timing chart for explaining an operation of the conventional decoder;

FIG. 4 is a block diagram illustrating a decoding apparatus which may be applied with an embodiment;

FIG. 5 is a block diagram illustrating a first embodiment;

FIG. 6 is a timing chart for explaining an operation of a decoder in the first embodiment;

FIG. 7 is a block diagram illustrating a second embodiment;

FIG. 8 is a diagram illustrating 3 consecutive macro blocks;

FIG. 9 is a diagram for explaining a processing timing for a case where a motion vector buffer is provided; and

FIG. 10 is a diagram illustrating an example of a format of motion vector data stored in a motion vector data storage part.

### DESCRIPTION OF EMBODIMENTS

Preferred embodiments will be described with reference to the accompanying drawings.

According to one aspect, an image is divided (or segmented) into a plurality of rectangular regions (or areas), and dynamic image compression data based on motion compensation are decoded and expanded into an image that is stored in an image memory. An encoded data decoding part decodes the compression data and outputs coefficient data and motion vector data. A coefficient data storage part stores the coefficient data, and a motion vector data storage part stores the motion vector data. A coefficient data processing part generates a rectangular residual image by performing an inverse quantization process and an inverse frequency conversion process based on the coefficient data read from the coefficient data storage part, and the motion vector data processing part generates a rectangular predicted image by reading a reference image from the image memory based on the motion vector data read from the motion vector data storage part. A motion compensating part generates a decoded image by adding the residual image generated by the coefficient data processing part and the predicted image generated by the motion vector data processing part, and stores the decoded image in the image memory. A control part controls operation timings of the coefficient data processing part and the motion vector data processing part.

The motion vector data processing part includes a predicted image buffer configured to store the predicted image with respect to at least two or more rectangular regions, and a predicted image generation notifying part configured to notify the control part by a predicted image ready signal that the predicted image has been generated. Accordingly, the control part controls the operation timings described above in response to the predicted image ready signal. The predicted image generation notifying part may be configured to notify the control part by a predicted image ready signal that the predicted image has been generated with respect to at least two or more rectangular regions.

Accordingly, it may be possible to provide a decoding method, a decoder and a decoding apparatus, which may reduce the delay that may be introduced for each macro block process, even if a delay is introduced in the predicted image generating process, in order to prevent the decoding performance from becoming deteriorated.

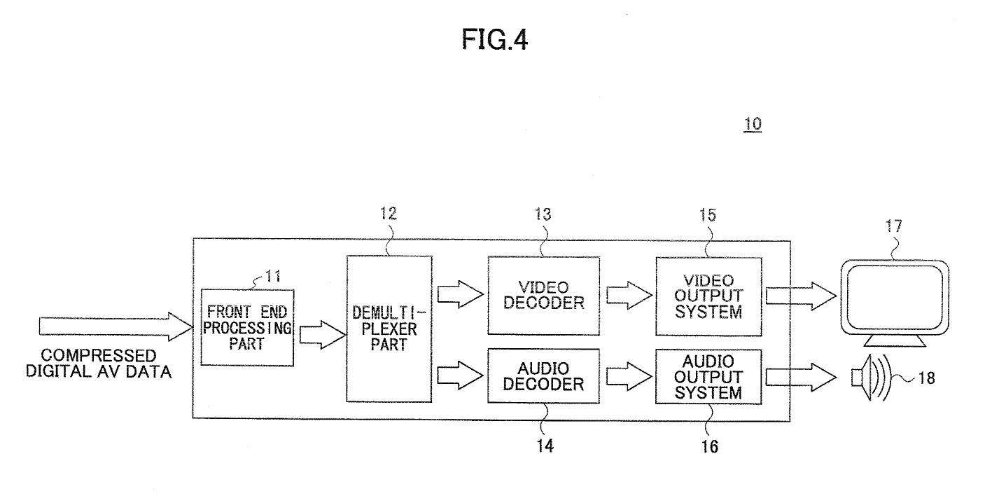

A description will now be given of a decoding method, a decoder and a decoding apparatus in each embodiment, by referring to FIG. 4 and the subsequent drawings.

### First Embodiment

FIG. 4 is a block diagram illustrating a decoding apparatus which may be applied with an embodiment. A decoding apparatus 10 includes a front end processing part 11, a demultiplexer part 12, a video decoder 13, an audio decoder 14, a video output system 15, and an audio output system 16 which are connected as illustrated in FIG. 4. A part formed by at least the demultiplexer part 12, the video decoder 13, the audio decoder 14, the video output system 15 and the audio output system 16 may be formed by a single semiconductor chip or a module such as a Multi-Chip Module (MCM).

Compressed Audio Visual (AV) data are converted by the front end processing part 11 and the demultiplexer part 12 into encoded video data and encoded audio data having formats suited for the decoding performed by the corresponding decoders 13 and 14. The encoded video data are decoded by the video decoder 13 and displayed on a monitor 17 via the video output system 15. On the other hand, the encoded audio data are decoded by the audio decoder 14 and output from a speaker 18 via the audio output system 16.

The decoding apparatus 10 is implemented in an apparatus having a video reproducing function, such as a video player/recorder and a video camera. The basic structure of the decoding apparatus 10 itself is known, but the decoder 13 according to one aspect has a structure or features which will be described below, unlike the conventional decoder.

The decoder 13 expands (or decodes) a video stream (or encoded video data) of the dynamic image in conformance with a dynamic compression technique which performs an inter-frame prediction typified by the standards such as the MPEG-2, MPEG-4 and H.264.

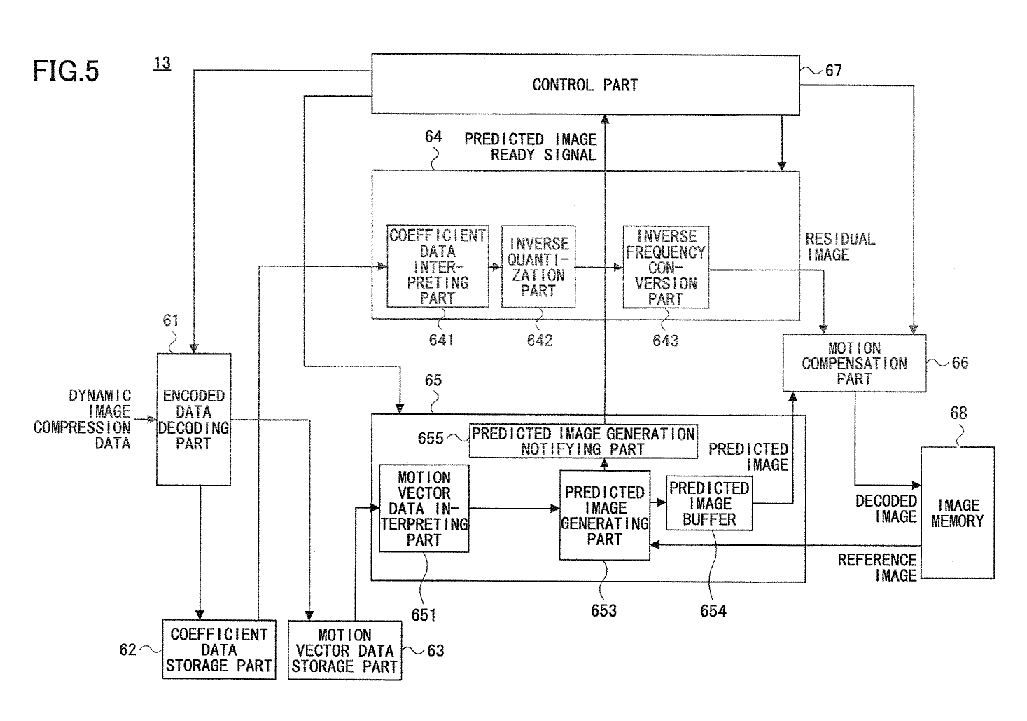

FIG. 5 is a block diagram illustrating a first embodiment. The decoder 13 divides (or segments) the image into rectangular regions (or areas), and decodes and expands the dynamic image compression data into the image based on the motion prediction (or compensation). This decoder 13 includes an encoded data decoding part 61, a coefficient data storage part 62, a motion vector data storage part 63, a coefficient data processing part 64, a motion vector data processing part 65, a motion compensating part 66, a control part 67, and an image memory 68 which are connected as illustrated in FIG. 5. The image memory 68 may be formed by an external memory that is connectable to the decoder 13, and the image memory 68 is not an essential constituent element of the decoder 13.

The encoded data decoding part 61 interprets the encoded data for each macro block, and classifies the encoded data into the coefficient data and the motion vector data, without synchronizing to the macro block processes of the coefficient data processing part 64 and the motion vector data processing part 65. The encoded data decoding part 61 stores the coefficient data into the coefficient data storage part 62 and stores the motion vector data into the motion vector data storage part 63. In this embodiment, the motion vector data storage part 63 may store at least two or more motion vector data. The coefficient data storage part 62 and the motion vector data storage part 63 may be formed by separate storage parts or, may be formed by different storage regions (or areas) of a single (that is, the similar) storage part.

The control part 67 controls the operation timings of the encoded data decoding part 61, the coefficient data processing part 64, the motion vector data processing part 65, and the motion compensating part 66.

The coefficient data processing part 64 includes a coefficient data interpreting part 641, an inverse quantization part 642, and an inverse frequency conversion part 643. The coefficient data interpreting part 641 converts a macro block attribute in accordance with a compression rule, such as interpreting the order of the coefficient data within the macro block, into a data format handled by hardware. The coefficient data output from the coefficient data interpreting part 641 has been subjected to a quantization at the time of the compression, and thus, is subjected to an inverse quantization process in the inverse quantization part 642. In addition, because the image compression data has been subjected to a spatial and frequency conversion in accordance with the compression rule, the image compression data is then subjected to an inverse frequency conversion process in the inverse frequency conversion part 643, in order to output the residual image that is obtained by subtracting the predicted image from the original image. The residual image includes an error component generated by the compression process such as the spatial and frequency conversion and quantization, and this error component appears as a distortion in the decoded image.

On the other hand, the motion vector data processing part 65 includes a motion vector data interpreting part 651, a predicted image generating part 653, a predicted image buffer 654, and a predicted image generation notifying part 655. The motion vector data processing part 65 reads the motion vector data from the motion vector data storage part 63 and interprets the motion vector data. In addition, the motion vector data processing part 65 generates the predicted image by reading from the image memory 68 the reference image indicated by the interpreted motion vector, and stores the predicted image in the predicted image buffer 654 which may store the predicted images of at least two or more macro blocks. Further, the motion vector data processing part 65 processes the motion vector data of the next macro block to generate the predicted image and stores the predicted image in the predicted image buffer 654, if the data to be processed is stored in the motion vector data storage part 63 and the predicted image buffer 654 has a sufficient vacant space, without achieving synchronization in units of macro blocks.

Every time the predicted image is stored in the predicted image buffer 654, the motion vector data processing part 65 outputs a prediction image ready signal to the control part 67 from the predicted image generation notifying part 655. The control part 67 confirms the receipt of the predicted image ready signal with respect to the macro block requiring the motion compensation, and controls the start of the motion compensation operation of the motion compensation part 66 for the macro block corresponding to the predicted image ready signal. Hence, the motion vector data processing part 65 averages the performance among the macro blocks that may be processed at a high speed, such as the macro block requiring the motion compensation and the macro block having a simple block division, and the macro blocks that are processed at a low speed, such as the macro block requiring the motion compensation and the macro block having a complex block division. By averaging the performance among the macro blocks in this manner, the motion vector data processing part 65 may suppress the deterioration of the performance of the decoder 13 as a whole caused by the low-speed reading of the reference image.

The motion compensation part 66 generates a decoded image by adding the residual image output from the coefficient data processing part 64 and the predicted image output from the motion vector data processing part 65, and stores the decoded image in the image memory 68.

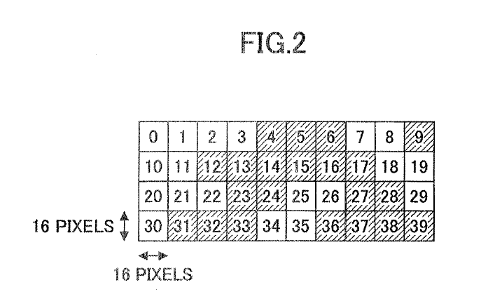

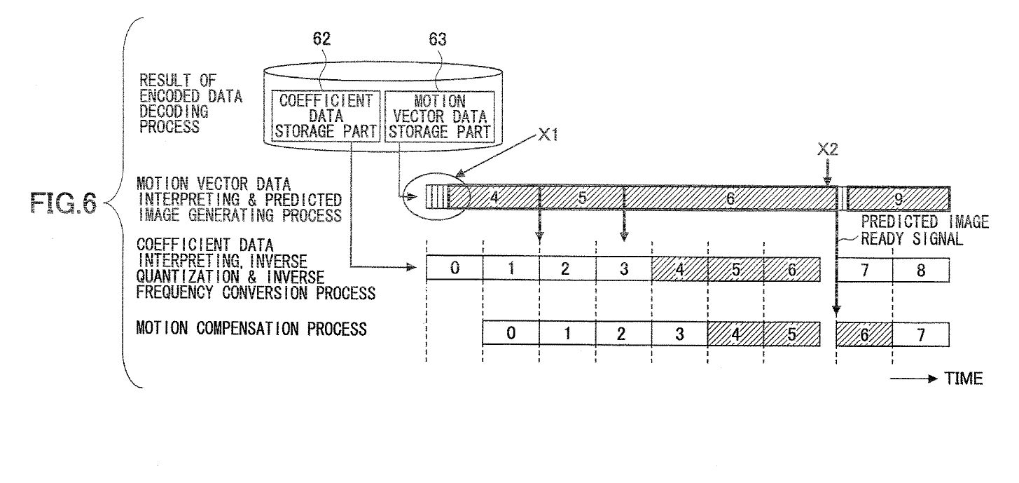

FIG. 6 is a timing chart for explaining an operation of the decoder 13 in the first embodiment. FIG. 6 illustrates the macro block processing timings of the decoder 13 for a case in which the macro blocks of the decoded image have the structure illustrated in FIG. 2. FIG. 6 illustrates the timings of the motion vector data interpreting process and the predicted image generating process (or reference image reading process) of the motion vector data processing part 65, the coefficient data interpreting, inverse quantization and inverse frequency conversion process of the coefficient data processing part 64, and the motion compensation process of the motion compensation part 66, as a result of the encoded data decoding process of the encoded data decoding part 61.

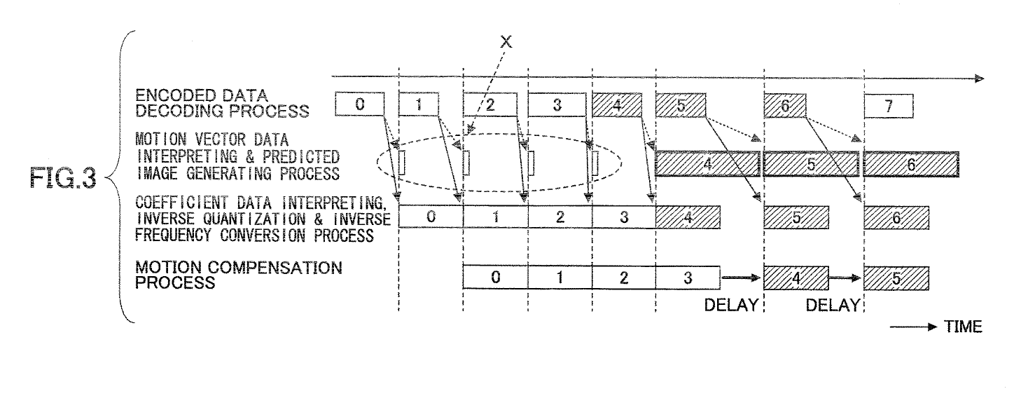

The motion vector data processing part 65 does not perform a timing synchronization with respect to the coefficient data processing part 64 for each macro block. Accordingly, as illustrated in FIG. 6, when it is judged that processing of the motion vector data may be unnecessary for the macro block numbers 0 to 3, the process immediately makes a transition to the processing of the next macro block. With respect to the macro block number 4 requiring the motion compensation, the predicted image is generated by reading the reference image and the predicted image is stored in the predicted image buffer 654, and the process makes a transition to the processing of the next macro block number 5 immediately after outputting the predicted image ready signal. At the point in time when the predicted image ready signal is output, the motion compensation part 66 does not yet require the predicted image of the macro block number 4, and thus, a delay caused by the generation of the predicted image of the macro block number 4 will not occur as in the case illustrated in FIG. 3. The similar holds true for the macro block number 5 which is the next processing target and requires the motion compensation. The macro block number 6 requiring the motion compensation in FIG. 6 illustrates an example of a case where the reading of the reference image and the generation of the predicted image are extremely delayed. Because the motion compensation part 66 completes the motion compensation process for the macro block number 5 during the time in which the predicted image generating process for the macro block number 6 is performed, the motion compensation part 66 waits for the generation of the predicted image. The control to cause the motion compensation part 66 to wait is performed by the control part 67 in response to the predicted image ready signal from the predicted image generation notifying part 655 within the motion vector data processing part 65. Of course, the predicted image ready signal may be supplied directly to the motion compensation part 66 in order to control the motion compensation part 66 to wait.

As indicated by X1 in FIG. 6, the processing of the intra-macro block is completed in a relatively short time, and the process makes a transition to the processing of the next macro block. On the other hand, as indicated by X2 in FIG. 6, if the generation of the predicted image is extremely slow as in the case of the macro block number 6, the delay is generated because the control part 67 controls the motion compensation part 66 to wait based on the predicted image ready signal. However, compared to the case illustrated in FIG. 3, the delay which may be introduced for the processing of each macro block may be reduced in this embodiment, and this embodiment may effectively prevent the performance of the decoder 13 as a whole from deteriorating.

### Second Embodiment

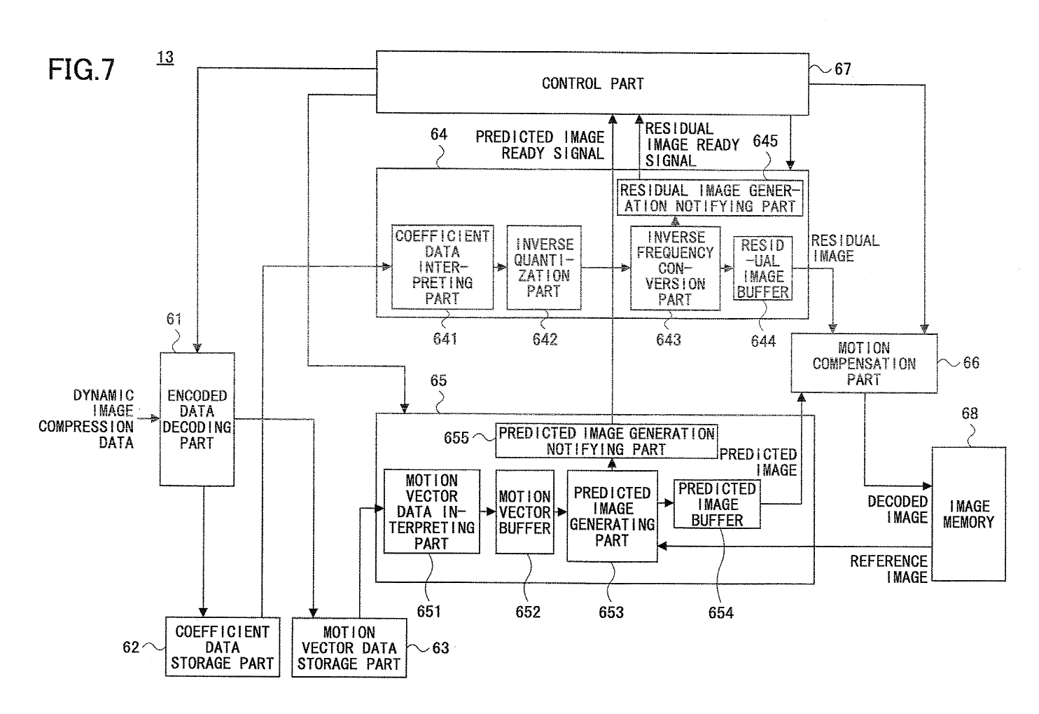

FIG. 7 is a block diagram illustrating a second embodiment. In FIG. 7, those parts that are the similar to those corresponding parts in FIG. 5 are designated by the similar reference numerals, and a description thereof will be omitted. In this embodiment, a residual image buffer 644 and a residual image generation notifying part 645 are provided within the coefficient data processing part 64, and a motion vector buffer 652 is provided within the motion vector data processing part 65.

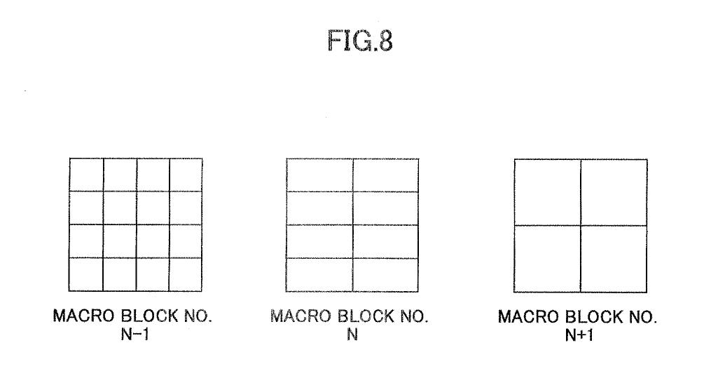

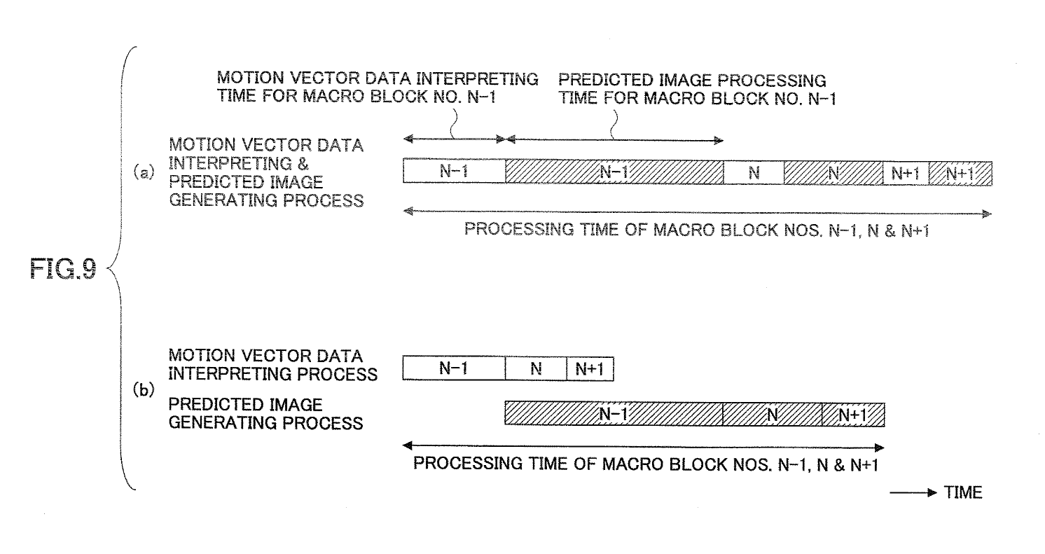

The effects of averaging the reference image read performance caused by the block division were described in conjunction with FIG. 6 for the first embodiment. As the block division becomes more complex, the processing speed of the motion vector data interpreting part 651 deteriorates more. Hence, in this second embodiment, the motion vector buffer 652 is provided in order to suppress the deterioration of the performance of the decoder 13 as a whole caused by the deterioration in the performance of the motion vector data analyzing part 651 within the motion vector data processing part 65. A description will now be given of the effects of the motion vector buffer 652, by referring to FIGS. 8 and 9.

FIG. 8 is a diagram illustrating 3 consecutive macro blocks. In this embodiment, it is assumed for the sake of convenience that the macro block numbers N−1, N and N+1 are processed as illustrated in FIG. 8. As illustrated in FIG. 8, the macro block number N−1 is divided into 16 small blocks (or small rectangular regions), the macro block number N is divided into 8 small blocks, and the macro block number N+1 is divided into 4 small blocks.

FIG. 9 is a diagram for explaining a processing timing of the macro block numbers N−1, N and N+1 illustrated in FIG. 8 for a case where the motion vector buffer 652 is provided. FIG. 9(a) illustrates the processing timing for the case where the motion vector buffer 652 is not provided, and in this case, the motion vector data interpreting process of the motion vector data interpreting part 651 and the predicted image generating process of the predicted image generating part 653 are successively executed as illustrated, with respect to the macro block numbers N−1, N and N+1. On the other hand, FIG. 9(b) illustrates the processing timing for a case where the motion vector buffer 652 is provided, and in this case, the motion vector data interpreting process of the motion vector data interpreting part 651 and the predicted image generating process of the predicted image generating part 653 are successively executed as illustrated, with respect to the macro block numbers N−1, N and N+1. As may be seen from FIG. 9(b), by the provision of the motion vector buffer 652, it may be possible to execute the motion vector data interpreting process with respect to the macro block number N and the macro block number N+1 after the motion vector data interpreting process with respect to the macro block number N−1, even in a stage where the predicted image generating process for the macro block number N−1 is not yet completed. Hence, as may be seen from a comparison of FIGS. 9(a) and 9(b), the processing time of the macro block numbers N−1, N and N+1 is reduced in this second embodiment, and the processing performance of the motion vector data processing part 65 may be improved in this embodiment.

Furthermore, this second embodiment provides the residual image buffer 644 in a stage following the inverse frequency conversion part 643 within the coefficient data processing part 64. For this reason, even in the case of the macro block number 6 illustrated in FIG. 6, for example, the inverse frequency conversion part 643 may immediately process the macro block number 7 following the macro block number 6.

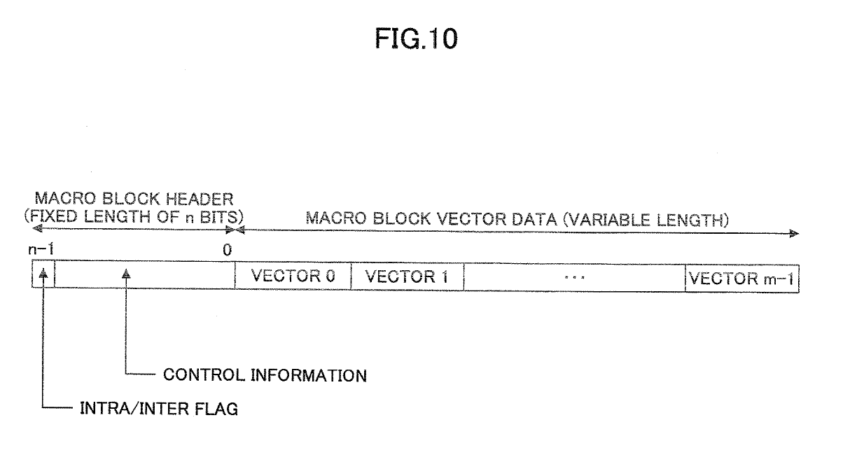

FIG. 10 is a diagram illustrating an example of a format of motion vector data stored in the motion vector data storage part 63. As illustrated in FIG. 10, the motion vector data (or macro block vector data) is added with a macro block header having a fixed length of n bits for each macro block. The header includes a field (or intra/inter flag field) for an intra/inter flag which indicates whether the macro block requires motion compensation. Information within the header has a different format depending on whether the value within the intra/inter flag field indicates the intra-macro block or the inter-macro block. The number of consecutive intra-macro blocks is set within the header if the intra/inter flag indicates the intra-macro block requiring no motion compensation. On the other hand, if the intra/inter flag indicates the inter-macro block requiring motion compensation, control information required for the motion compensation is set within the header, and a required number motion vector data is added following the header. In other words, the header includes the intra/inter flag, and the control information depending on whether the macro block is the intra-macro block or the inter-macro block. The control information includes the number of consecutive intra-macro blocks in the case of the intra-macro block, and includes information such as the block division information and the reference image information in the case of the intra-macro block. The motion vector data is made up of vector data in accordance with the control information within the header, and includes no payload data in the case of the intra-macro block.

If the intra-macro blocks are consecutive as in the case of the macro block numbers 0 to 3 illustrated in FIG. 2, the motion vector data interpreting part 651 may simultaneously process 4 intra-macro blocks based on the information within the header, and the processing speed of the motion vector data interpreting part 651 may be improved. In other words, if no motion compensation is required, the vector data processing part 65 may skip the processing of the data of one or a plurality of rectangular regions, and the process may make a transition to the processing of the data of the next rectangular region requiring the motion compensation.

In addition, in this second embodiment, the residual image buffer 644 stores one or more residual images in units of the rectangular regions generated by the inverse frequency conversion process of the inverse frequency conversion part 643 within the coefficient data processing part 64, and the residual image generation notifying part 645 notifies by the residual image ready signal that the residual image has been generated. For this reason, the control part 67 controls the operation timings of the encoded data decoding part 61, the coefficient data processing part 64, the motion vector data processing part 65 and the motion compensation part 66, based on the predicted image ready signal and the residual image ready signal from the residual image generation notifying part 645.

A dynamic image decoding apparatus according to one aspect may conceal the inconsistencies in the load of reading the reference images stored in an external image memory. Hence, it may be possible to provide a dynamic image decoding apparatus having a stable decoding performance.

Aforementioned embodiments may be applied to a decoder and a decoding apparatus for decoding compressed and encoded dynamic image data when receiving digital broadcasting or reproducing video data from Digital Versatile Disks (DVDs).

According to any one of the aforementioned embodiments, the delay that may be introduced for each macro block process may be reduced, even if a delay is introduced in the predicted image generating process, in order to prevent the decoding performance from becoming deteriorated.

Although the embodiments are numbered with, for example, “first,” “second,” or “third,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification related to a showing of the superiority and inferiority of the invention. Although the embodiments have been described in detail, it should be understood that the various changes, substitutions, and alterations could be made hereto without departing from the spirit and scope of the invention.

1. A decoding method which decodes video compression data based on motion compensation for divided regions of the video image and decompresses the video compression data into an image that is stored in an image memory, comprising:
decoding the dynamic image compression data and outputting coefficient data and motion vector data;
storing the coefficient data in a coefficient data storage part;
storing the motion vector data in a motion vector data storage part;
generating a rectangular residual image by performing an inverse quantization process and an inverse frequency conversion process based on the coefficient data read from the coefficient data storage part;
generating a rectangular predicted image by reading a reference image from the image memory based on the motion vector data read from the motion vector data storage part;
generating a decoded image by adding the residual image and the predicted image, and storing the decoded image in the image memory;
controlling processing timings of the storing of the coefficient data to the coefficient data storage part and the storing of the motion vector data to the motion vector data storage part; and
storing predicted images with respect to at least two or more rectangular regions in a predicted image buffer when generating the rectangular predicted image by reading the reference image from the image memory, and notifying by a predicted image ready signal that the predicted image has been generated,
wherein the processing timings are controlled in response to the predicted image ready signal.

2. The decoding method as claimed in claim 1, wherein:
each rectangular data of the motion vector data is added with a flag indicating whether the motion compensation is required; and
when generating the rectangular predicted image by reading the reference image from the image memory, processing of a corresponding rectangular data is skipped to processing of next rectangular data if the flag indicates that no motion compensation is required.

3. The decoding method as claimed in claim 1, wherein:
the motion vector data is added with control information indicating a number of consecutive rectangular data requiring no motion compensation; and
when generating the rectangular predicted image by reading the reference image from the image memory, processing of the number of rectangular data indicated by the control information is skipped simultaneously to processing of next rectangular data requiring the motion compensation.

4. The decoding method as claimed in claim 3, wherein the control information includes rectangular region division information and information of the reference image with respect to the rectangular data requiring the motion compensation.

5. The decoding method as claimed in claim 1, wherein:
when generating the rectangular predicted image by reading the reference image from the image memory, if data to be processed is stored in the motion vector data storage part and the predicted image buffer has a sufficient vacant space, processing the motion vector data of a next rectangular region to generate a predicted image without achieving synchronization in units of the rectangular regions and storing the predicted image based on the motion vector data of the next rectangular region in the predicted image buffer.

6. The decoding method as claimed in claim 1, wherein:
when generating the rectangular residual image, storing the residual image in a residual image buffer configured to store one or more residual images generated by the inverse frequency conversion process in units of the rectangular regions, and notifying by a residual image ready signal that the residual image has been generated; and
the processing timings are controlled based on the predicted image ready signal and the residual image ready signal.

7. A decoder decodes video compression data based on motion compensation for divided regions of the video image and decompresses the video compression data into an image that is stored in an image memory, comprising:
an encoded data decoding part configured to decode the dynamic image compression data and to output coefficient data and motion vector data;
a coefficient data storage part configured to store the coefficient data;
a motion vector data storage part configured to store the motion vector data;
a coefficient data processing part configured to generate a rectangular residual image by performing an inverse quantization process and an inverse frequency conversion process based on the coefficient data read from the coefficient data storage part;
a motion vector data processing part configured to generate a rectangular predicted image by reading a reference image from the image memory based on the motion vector data read from the motion vector data storage part;
a motion compensation part configured to generate a decoded image by adding the residual image and the predicted image, and to store the decoded image in the image memory; and
a control part configured to control operation timings within the decoder,
wherein the motion vector data processing part includes a predicted image buffer configured to store predicted images with respect to at least two or more rectangular regions, and a predicted image generation notifying part configured to notify by a predicted image ready signal that the predicted image has been generated, and
the control part controls the operation timings in response to the predicted image ready signal from the predicted image generation notifying part.

8. The decoder as claimed in claim 7, wherein:
each rectangular data of the motion vector data is added with a flag indicating whether the motion compensation is required; and
the motion vector data processing part skips processing of a corresponding rectangular data to processing of next rectangular data if the flag indicates that no motion compensation is required.

9. The decoder as claimed in claim 7, wherein:
the motion vector data is added with control information indicating a number of consecutive rectangular data requiring no motion compensation; and
the motion vector data processing part simultaneously skips processing of the number of rectangular data indicated by the control information to processing of next rectangular data requiring the motion compensation.

10. The decoder as claimed in claim 9, wherein the control information includes rectangular region division information and information of the reference image with respect to the rectangular data requiring the motion compensation.

11. The decoder as claimed in claim 7, wherein:
the motion vector data processing part processes the motion vector data of a next rectangular region to generate a predicted image without achieving synchronization in units of the rectangular regions and stores the predicted image based on the motion vector data of the next rectangular region in the predicted image buffer, if data to be processed is stored in the motion vector data storage part and the predicted image buffer has a sufficient vacant space.

12. The decoder as claimed in claim 7, wherein:
the coefficient data processing part includes a residual image buffer configured to store one or more residual images generated by the inverse frequency conversion process in units of the rectangular regions, and a residual image generation notifying part configured to notify by a residual image ready signal that the residual image has been generated; and
the control part controls the processing timings based on the predicted image ready signal and the residual image ready signal.

13. The decoder as claimed in claim 7, further comprising:
the image memory.

14. A decoding apparatus comprising:
a decoder; and
an input part configured to convert compressed digital audio visual data into encoded video data and encoded audio data having formats suited for decoding, and to input the encoded video data and the encoded audio data to the decoder as dynamic image compression data,
wherein the decoder decodes video compression data based on motion compensation for divided regions of the video image and decompresses the video compression data into an image that is stored in an image memory, said decoder comprising:
an encoded data decoding part configured to decode the dynamic image compression data and to output coefficient data and motion vector data;
a coefficient data storage part configured to store the coefficient data;
a motion vector data storage part configured to store the motion vector data;
a coefficient data processing part configured to generate a rectangular residual image by performing an inverse quantization process and an inverse frequency conversion process based on the coefficient data read from the coefficient data storage part;
a motion vector data processing part configured to generate a rectangular predicted image by reading a reference image from the image memory based on the motion vector data read from the motion vector data storage part;
a motion compensation part configured to generate a decoded image by adding the residual image and the predicted image, and to store the decoded image in the image memory; and
a control part configured to control operation timings within the decoder,
wherein the motion vector data processing part includes a predicted image buffer configured to store predicted images with respect to at least two or more rectangular regions, and a predicted image generation notifying part configured to notify by a predicted image ready signal that the predicted image has been generated, and
the control part controls the operation timings in response to the predicted image ready signal from the predicted image generation notifying part.
